(19) United States
(12) Patent Application Publication
(10) Pub. No.: US 2011/0081509 A1
(43) Pub. Date: Apr. 7, 2011

(54) DEGRADABLE HEAT INSULATION CONTAINER

(76) Inventor: CHING-WEN CHANG, Taichung (TW)

(21) Appl. No.: 12/574,247

(22) Filed: Oct. 6, 2009

(51) Int. Cl. B32B 1/06

(52) U.S. Cl. 428/34.2

(57) ABSTRACT

A container of the present invention includes a paper-made container body, a waterproofing layer and a foaming layer. The container body has an outer surface and an inner surface. The waterproofing layer is coated on the inner surface in the manner of casting. The waterproofing layer mainly consists of talcum powder, resin and calcium carbonate. The foaming layer is disposed on at least a part of the outer surface. The foaming layer consists of a hinder and a thermo-expandable powder. The binder is selected from a group consisting of polyvinyl acetate resin, ethylene vinyl acetate resin, polyacrylic acid resin and a mixture thereof. The thermo-expandable powder consists of a plurality of thermo-expandable microcapsules, each of which consists of a thermoplastic polymer shell and a low-boiling-point solvent wrapped by the thermoplastic polymer shell.

### BACKGROUND OF THE INVENTION

1. Field of the Invention

The present invention relates to a container, and more particularly to a degradable heat insulation container.

2. Description of the Prior Art

Conventional paper-made container is coated with a PE casting layer. However, the PE casting layer cannot be removed from the container once it is coated on the container. As such, the paper-made container becomes undegradable.

A degradable container made of a biomaterial, i.e. polylactic acid (PLA), is developed to mitigate the above mentioned disadvantages, yet it arises other disadvantages as follows:

(1) Polylactic acid is undegradable in the normal environment. The biodegrading treatment of PLA can only be done in an airtight garbage disposer with the help of anaerobic bacteria.

(2) The biodegrading treatment of PLA produces methane, which is a greenhouse gas 23 times more serious than carbon dioxide is.

(3) The appearance of PLA is substantially identical to that of PET. People usually confuse these two materials and put them into the same recovery processing system. Therefore, the recoverable PET waste is polluted by the un-recoverable PEA, which leads to the surface peeling-oft of the reclaimed PET product.

(4) The PLA is made from corn, which is originally a source of food. The large consumption of corn affects the food supply and leads to price ballooning of food.

Due to the disadvantages mentioned hereinabove, many countries or districts have decided or considered to forbid or at least not to recommend the use of PLA.

Since the PLA products seem not to be a good solution of the plastic pollution, the seeking of environmental friendly material has never ceased for any moment. The invention is, therefore, arisen to obviate or at least mitigate the above mentioned disadvantages.

### SUMMARY OF THE INVENTION

The main object of the present invention is to provide a degradable heat insulation container.

To achieve the above object, a container of the present invention includes a paper-made container body, a waterproofing layer and a foaming layer. The container body has an outer surface and an inner surface for directly contacting food or drink. The waterproofing layer is coated on the inner surface in the manner of casting. The waterproofing layer mainly consists of talcum powder, resin and calcium carbonate. The foaming layer is disposed on at least a part of the outer surface. The foaming layer consists of a hinder and a thermo-expandable powder. The binder and the thermo-expandable powder are pre-blended and coated on the outer surface, and then the binder and the thermo-expandable powder are heated to form the foaming layer. The hinder is selected from a group consisting of polyvinyl acetate resin, ethylene vinyl acetate resin, polyacrylic acid resin and a mixture thereof. The thermo-expandable powder consists of a plurality of thermo-expandable microcapsules, each of which consists of a thermoplastic polymer shell and a low-boiling-point solvent wrapped by the thermoplastic polymer shell.

Whereby, the container body, the waterproofing layer and the foaming layer are all biodegradable. In addition, the container is waterproofing in the inner surface and is heat insulated in the outer surface, which satisfies the user's need.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a profile showing a container of the present invention;

FIG. 2 is a breakdown drawing showing a cup-shaped container of the present invention;

FIG. 3 is a combination drawing showing a cup-shaped container of the present invention.

### DETAILED DESCRIPTION OF THE PREFERRED EMBODIMENTS

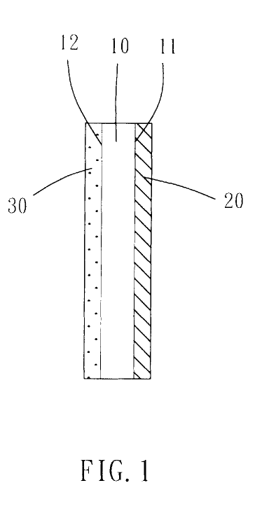

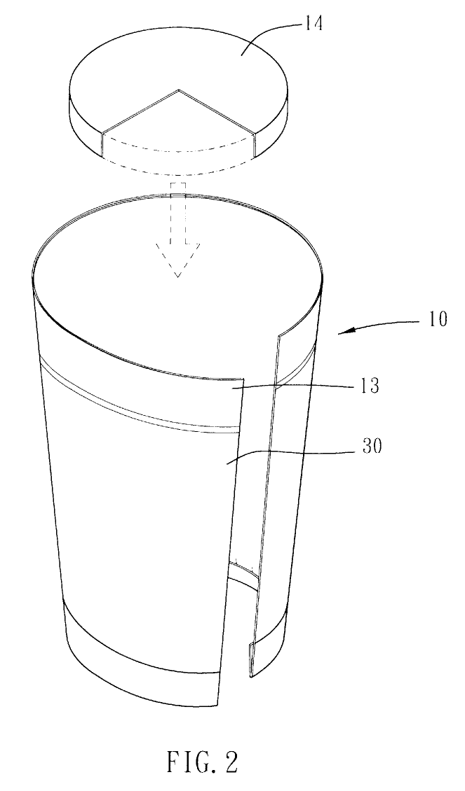

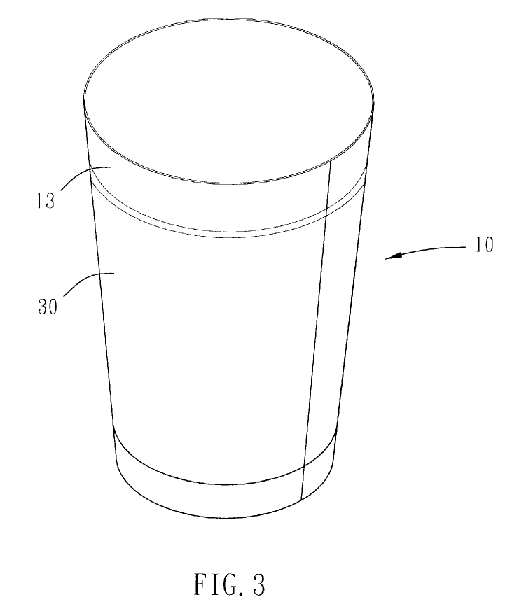

Please refer to FIG. 1 to FIG. 3. A degradable heat insulation container of the present invention includes a container body 10, a waterproofing layer 20 and a foaming layer 30.

The container body 10 has an outer surface 12 and an inner surface 11 for directly contacting food or drink. In the present embodiment, the container body 10 is cup-shaped, i.e. the container body 10 includes a body portion 13 and a bottom portion 14 disposed under the body portion 13. The body portion 13 and the bottom portion 14 define a receiving space to receive water, other liquid or food therein. The waterproofing layer 20 is preferably casting in inner surfaces of the body portion 13 and the bottom portion 14, providing the waterproofing property to the container. The foaming layer 30 is, on the contrary, disposed on at least a part of an outer surface of the body portion 13, i.e. the foaming layer 30 can be disposed on the partial or entire surface of the body portion 13. The foaming layer 30 may also have hollow portions or form 3D patterns.

The waterproofing layer 20 is coated on the inner surface of the container body 10 in the manner of casting. In an embodiment, the waterproofing layer 20 mainly consists of talcum powder, resin and calcium carbonate. More specifically, the waterproofing layer 20 consists of 15-40 parts by weight of talcum powder, 2-10 parts by weight of resin, and 50-83 parts by weight of calcium carbonate. The resin is an epoxy resin in the present embodiment. In another embodiment, the waterproofing layer 20 mainly consists of 15-40 parts by weight talcum powder, 2-10 parts by weight of resin, 50-83 parts by weight of calcium carbonate, and 10-70 parts by weight of polyolefin. The polyolefin is selected from the group consisting of polyethylene, polypropylene, polystyrene and a mixture thereof. The waterproofing layer 30 of the present invention has a significant stretching rate and better properties of waterproofing, aging resistance and surface smoothness. In addition, the waterproofing layer 30 is stable either in the heated or chemical environment. Thus the waterproofing layer 30 is very suitable to be used as an inner layer of a drink container. More importantly, the waterproofing layer of the present invention is biodegradable and can be removed from the container body. Even when the container is incinerated, the waterproofing layer produces none toxic product after burned. For sterilization and other purposes, the waterproofing layer may further consist of far-infrared material particles and nano-silver particles.

The foaming layer 30 consists of a hinder and a thermo-expandable powder. The hinder and the thermo-expandable powder are pre-blended and coated on the outer surface, and then the binder and the thermo-expandable powder are heated to foam the foaming layer. Note that the binder and the thermo-expandable powder can be dried before foaming, thus the dried semi-finished container can be stored without foaming. The manufacturer can, therefore, allocate the manufacturing capacity more efficiently and more flexibly. In the present invention, the hinder is selected from the group consisting of polyvinyl acetate resin, ethylene vinyl acetate resin, polyacrylic acid resin and a mixture thereof. The thermo-expandable powder consists of a plurality of thermo-expandable microcapsules, each of which consists of a thermoplastic polymer shell and a low-boiling-point solvent wrapped by the thermoplastic polymer shell. Pigments can be further blended into the pre-blended mixture of the hinder and the thermo-expandable powder.

In the foaming process, the hinder begins to soften before the low-boiling-point solvent reaches its boiling point. Once the solvent reaches its boiling point, it balloons the thermoplastic polymer shell, and the pre-softened binder can flow into the micro gaps between expanded thermo-expandable microcapsules. As such, the surface of the foaming layer is smoother and can, therefore, be printed with figures. In addition, the foaming layer is a close cell structure, and the micro gaps between microcapsules are filled by the binder, thus the foaming layer is also watertight. The foaming temperature is preferably controlled within 80-160 degrees Celsius, and is preferably heated gradually to get a stable foaming process such that the microcapsule will not break. With the foaming layer, the heat must be transmitted through different phases and different materials, i.e. the thermo coefficient is low. Thus the container of the present invention is heat insulated. More importantly, the foaming layer of the present invention is also biodegradable with the help of aerobic bacteria. Thus the foaming layer can be degraded into water and carbon dioxide, which is extremely environmental friendly.

In summarization, the waterproofing layer and the foaming layer of the present invention are both biodegradable and environmental friendly. Both layers are easy to be coated on the container body with excellent properties. In addition, no food resource is consumed during the preparation of both layers. Although the container of the above embodiment is cup-shaped, it can still be formed into other shapes such as a howl, a plate, a box or the like.

What is claimed is:

1. A degradable heat insulation container, comprising:
a paper-made container body, having an outer surface and an inner surface for directly contacting food or drink;
a waterproofing layer, coated on the inner surface in a manner of casting, the waterproofing layer mainly consisting of talcum powder, resin and calcium carbonate.

2. The container of claim 1, wherein the waterproofing layer mainly consists of 15-40 parts by weight of talcum powder, 2-10 parts by weight of resin, and 50-83 parts by weight of calcium carbonate.

3. The container of claim 1, further comprising a foaming layer, disposed on at least a part of the outer surface, the foaming layer consisting of a binder and a thermo-expandable powder, the hinder and the thermo-expandable powder being pre-blended and coated on the outer surface, and then the binder and the thermo-expandable powder being heated to form the foaming layer, the binder being selected from a group consisting of polyvinyl acetate resin, ethylene vinyl acetate resin, polyacrylic acid resin and a mixture thereof, the thermo-expandable powder consisting of a plurality of thermo-expandable microcapsules, each of which consists of a thermoplastic polymer shell and a low-boiling-point solvent wrapped by the thermoplastic polymer shell.

4. The container of claim 3, wherein the container body includes a body portion and a bottom portion disposed under the body portion, the body portion and the bottom portion define a receiving space therein, the foaming layer is disposed on at least a part of an outer surface of the body portion.

5. The container of claim 1, wherein the waterproofing layer further consists of far-infrared material particles and nano-silver particles.

6. A degradable heat insulation container, comprising:
a paper-made container body, having an outer surface and an inner surface for directly contacting food or drink;
a waterproofing layer, coated on the inner surface in a manner of casting, the waterproofing layer mainly consisting of talcum powder, resin, calcium carbonate and polyolefin.

7. The container of claim 6, wherein the waterproofing layer mainly consists of 15-40 parts by weight of talcum powder, 2-10 parts by weight of resin, 50-83 parts by weight of calcium carbonate, and 10-70 parts by weight of polyolefin.

8. The container of claim 6, further comprising a foaming layer, disposed on at least a part of the outer surface, the foaming layer consisting of a binder and a thermo-expandable powder, the binder and the thermo-expandable powder being pre-blended and coated on the outer surface, and then the hinder and the thermo-expandable powder being heated to form the foaming layer, the binder being selected from a group consisting of polyvinyl acetate resin, ethylene vinyl acetate resin, polyacrylic acid resin and a mixture thereof, the thermo-expandable powder consisting of a plurality of thermo-expandable microcapsules, each of which consists of a thermoplastic polymer shell and a low-boiling-point solvent wrapped by the thermoplastic polymer shell

9. The container of claim 8, wherein the container body includes a body portion and a bottom portion disposed under the body portion, the body portion and the bottom portion define a receiving space, the foaming layer is disposed on at least a part of an outer surface of the body portion.

10. The container of claim 6, wherein the polyolefin is selected from a group consisting of polyethylene, polypropylene, polystyrene and a mixture thereof.

11. The container of claim 6, wherein the waterproofing layer further consists of far-infrared material particles and nano-silver particles.
